(19) United States
(12) Patent Application Publication
(10) Pub. No.: US 2006/0202499 A1
(43) Pub. Date: Sep. 14, 2006

(54) Sound insulating composite part

(76) Inventor: Heinz Blomeling, LEICHLINGEN (DE)

Correspondence Address: WILLIAM COLLARD;COLLARD & ROE, P.C., 1077 NORTHERN BOULEVARD, ROSLYN, NY, 11576, US

(21) Appl. No.: 10/565,307

(22) PCT Filed: May 22, 2004
(86) PCT No.: PCT/EP04/05531

§ 371 Date: Jan. 19, 2006

(30) Foreign Application Priority Data
Jul. 25, 2003 (DE) 103 34 273.7

(51) Int. Cl. B62D 25/00

(52) U.S. Cl. 296/39.3

(57) ABSTRACT

The present invention relates to a sound-insulating composite part, particularly for motor vehicles, comprising a heavy layer (7) and at least one layer (8) made of open-pored, elastic absorbing material. Multiple webs (9) are molded onto the heavy layer (7), which are made of the material of the underlay, the underlay material forming the webs (9) being pressed into and/or through the absorber layer (8). The webs (9) divide the absorber layer into multiple absorber areas (11) of different sizes and different thicknesses, which project like cushions in relation to the webs (9). The composite part may preferably be implemented as a floor covering of a motor vehicle, the absorber layer equalizing structure-related height differences, e.g., depressions in underlying vehicle body sheet metal.

The present invention relates to a sound-insulating composite part, particular for motor vehicles, comprising a heavy layer and at least one layer made of open-pored, elastic absorbing material.

Multiple different methods have become known in the related art for manufacturing sound-absorbing composite parts. The composite parts are frequently adapted to the shape of their installation location. This is particularly true for carpet parts, which are to be adapted to the contours of a motor vehicle floor.

For example, a method for manufacturing a carpet having molded foam backing for motor vehicles is disclosed in EP 0 169 627 A2, in which a carpet web product having a heavy layer is shaped corresponding to the vehicle body shape and subsequently partially back-foamed with soft foam at predefined points. In this case, the soft foam forms cushions of different thicknesses corresponding to the contour of the vehicle body floor.

DE 40 38 025 A1 describes a method for manufacturing a lining part for a motor vehicle, in which a heavy layer is cast or sprayed as a heavy layer compound in a mold on the back of a cover layer of a flat cover part, particularly a carpet product. The heavy layer compound is cast or sprayed onto the cover part in different thicknesses and correspondingly different area weights in accordance with the locally different acoustic requirements in this case.

A multilayered molded part, which is used as a thermal insulator or the like, is known from EP 0 249 939 A2. The known molded part has a body made of thermoplastic resin and an elastic foam layer, multiple webs being molded onto the body. The webs are made of the same material as the body, the material of the webs being pressed through the foam layer. In the exemplary embodiments described and explained, the thickness of the foam layer either corresponds to the height of the webs of the body, or the height of the webs is greater than the thickness of the foam layer.

The present invention is based on the object of specifying a sound-insulating composite part of the type cited at the beginning, which is particularly suitable as a floor covering for a motor vehicle and is adapted to the contour of the particular installation location with cost-effective manufacturing capability, the absorber layer to equalize structure-related height differences, e.g., depressions, which are pressed into vehicle body sheet metal used as a substrate.

This object is achieved by a sound-insulating composite part having the features of claim 1.

The composite part according to the present invention has a heavy layer and at least one absorber layer made of open-pored, elastic absorbing material. Multiple webs are molded onto the heavy layer, which are made of the material of the heavy layer. The heavy layer material forming the webs is pressed into and/or through the absorber layer. The webs divide the absorber layer into multiple absorber areas of different sizes and different thicknesses which project like cushions in relation to the webs.

The composite part according to the present invention has the advantage that the molding of the heavy layer or and its connection to at least one elastic, open-pored absorber layer is performed in only one work cycle. A further advantage of the present invention is that the height and width of the webs may be changed easily through a corresponding design of the molding press tool. For example, height differences in a floor sheet metal of a motor vehicle may be equalized very well by different web heights. With uniform thickness of the open-pored absorber layer, height equalization is additionally also implemented in that the spacing of the webs to one another or the size of the boxes formed by the webs is varied. In this way, absorber cushions of different thicknesses arise in the open-pored elastic absorber layer between the webs.

Furthermore, the present invention provides the possibility of manufacturing relatively large, acoustically effective linings, particularly dash wall and floor linings for motor vehicles, comparatively cost-effectively. This is because the flow molding or resin transfer molding applied for manufacturing the composite part according to the present invention allows relatively large-area heavy layers to be manufactured even from those plasticizable plastic compounds, particularly thermoplastic elastomers, which may be manufactured only with difficulty in injection molds, specifically, for example, only if complexly constructed injection molds are used and/or only by applying additives which improve the flow behavior of the plastic compounds. The pressing tools required for manufacturing the composite part according to the present invention, in contrast, are constructed comparatively simply and therefore may be obtained correspondingly cost-effectively. The heavy layer of the composite part according to the present invention may be molded in this case in such a way that it has areas of different thickness. In addition, the composite part according to the present invention allows an essentially waste-free and material-saving manufacturing of its heavy layer.

Preferred and advantageous embodiments of the present invention are specified in the subclaims.

In the following, the present invention will be explained in greater detail on the basis of a drawing illustrating several exemplary embodiments.

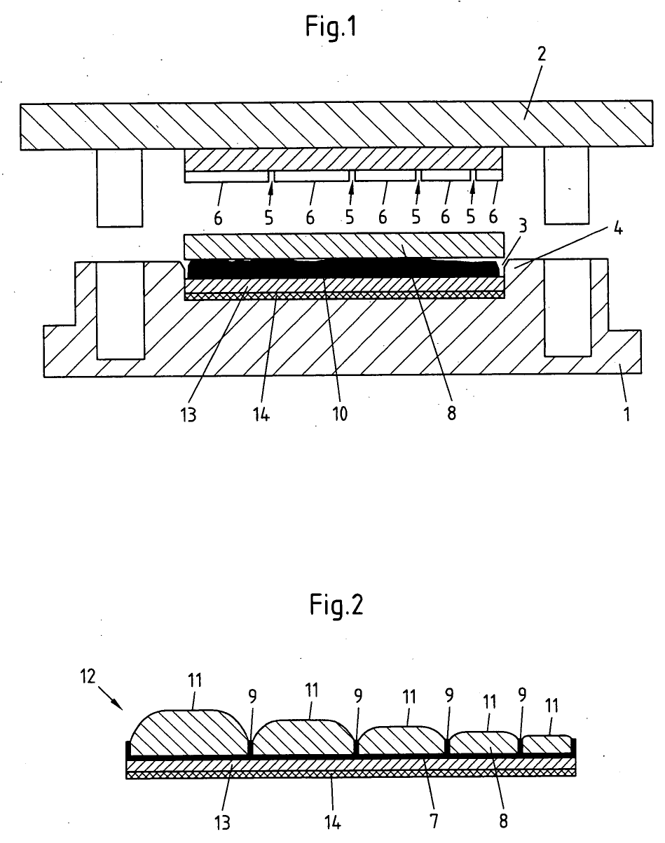

FIG. 1 shows a schematic cross-sectional view of the lower mold and the upper mold of a molding press in the open state;

FIG. 2 shows a schematic cross-sectional view of a sound-insulating composite part as may be manufactured using a molding press according to FIG. 1;

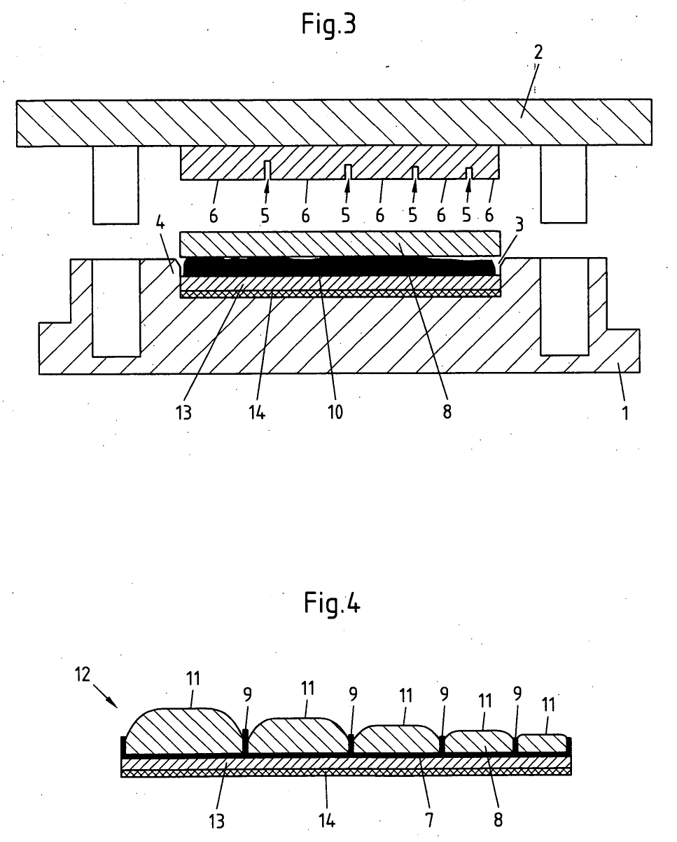

FIG. 3 shows a schematic cross-sectional view of the lower mold and the upper mold of a further molding press in the open state;

FIG. 4 shows a schematic cross-sectional view of a sound-insulating composite part as may be manufactured using a molding press according to FIG. 3;

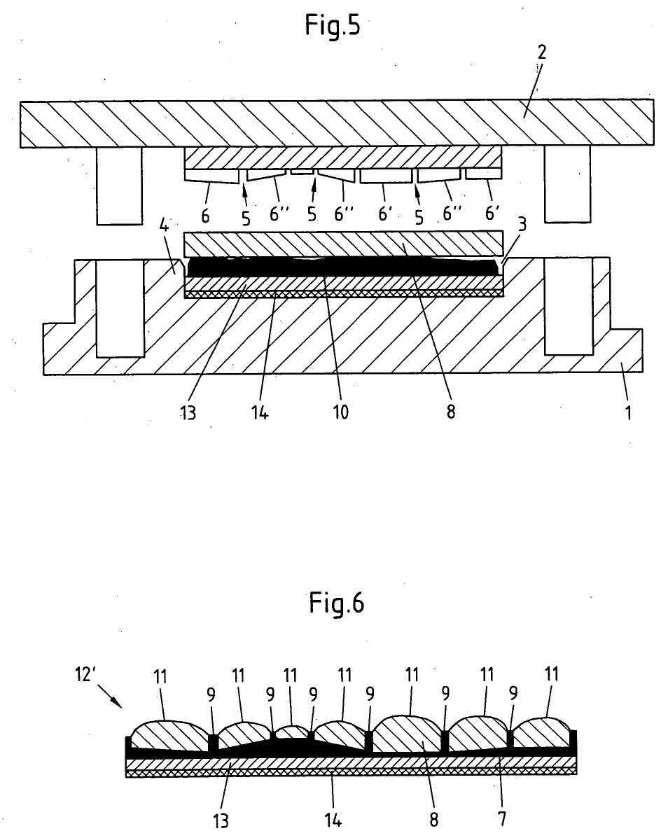

FIG. 5 shows a schematic cross-sectional view of the lower mold and the upper mold of a third molding press in the open state;

FIG. 6 shows a schematic cross-sectional view of a sound-insulating composite part as may be manufactured using a molding press according to FIG. 5; and

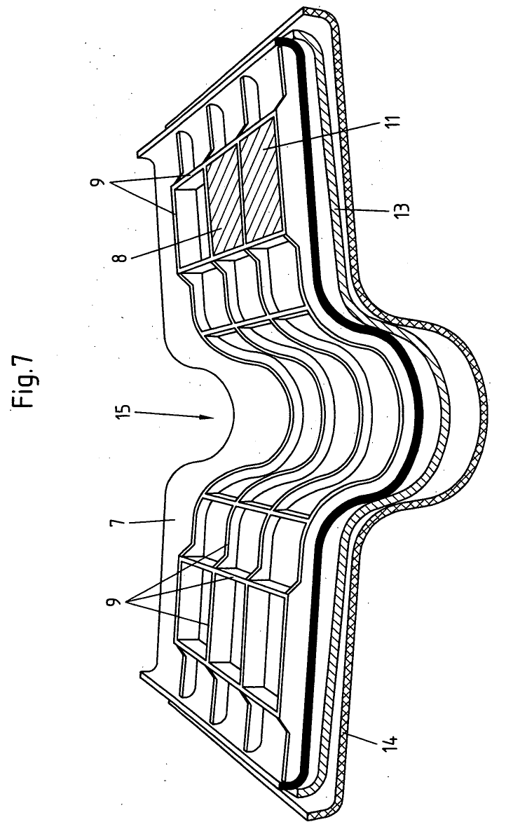

FIG. 7 schematically shows a perspective view of the bottom of a carpet construction for motor vehicles according to the present invention.

In FIGS. 1, 3, and 5, a lower molding tool (lower tool) is identified by 1 and an upper molding tool (upper tool) is identified by 2, in each case from a molding press, the rest of which is not shown in greater detail, for manufacturing a composite part according to the present invention. The upper tool 2 and/or the lower tool 1 may be equipped with a heating device (not shown) and/or a cooling device (not shown).

The lower tool 1 contains a mold cavity 3, which is defined by a peripheral flash edge 4. The upper tool 2 is designed in such a way that it may dip into the cavity 3 with slight play. The part of the upper tool 2 dipping into the cavity 3 has multiple recesses 5 which mold webs.

Furthermore, it may be seen that the recesses 5 are at different distances to one another. At least a part of the recesses 5 pass into one another in a ring or frame shape. Correspondingly, the recesses 5 define raised press panels 6 of different sizes. The positioning, shaping, and dimensions of the press panels 6 and/or recesses 5 is performed according to acoustic criteria and in adaptation to the geometric conditions at the installation location of the composite part to be manufactured using the molding press, as will be explained in greater detail below.

Different sound-insulating composite parts may be manufactured using the molds 1, 2 illustrated in FIGS. 1, 3, and 5. In this case, the composite parts have at least one heavy layer 7 and at least one layer 8 made of an open-pored, elastic absorbing material, webs 9 being molded on the heavy layer which are formed from the material of the heavy layer 7 in one piece with the heavy layer 7. The heavy layer 7 is formed essentially flat and essentially continuous, i.e., uninterrupted.

The heavy layer material is introduced into the open cavity 3 of the lower tool 1 as a plasticized compound 10 in the melt application molding method. The heavy layer material is a highly-filled plastic compound, preferably PE-EVA (polyethylene ethylene vinyl acetate) or a thermoplastic elastomer (TPE). In particular, the thermoplastic polyolefin elastomers TPO or TPV may be used, which comprises polypropylenes having up to 65% ethylene-propylene [diene] rubber (EP[D]M) incorporated. Furthermore, thermoplastic elastomers of the TPS (styrene TPE) type are also well suitable.

The plasticizing of the plastic compound 10 is performed using an extruder device (not shown). The plasticized compound is dosed in batches, each batch essentially corresponding precisely to the volume of a heavy layer 7 to be manufactured. The heavy layer 7 is therefore manufactured without waste by introducing a component-specific volume of the heavy layer material. Introducing heavy layer compound components having different compositions at specific points of the cavity 3 is within the scope of the present invention. The heavy layer compound components may particularly differ in this case in regard to their filler component, so that the heavy layer 7 manufactured therefrom finally has areas of different density and/or area weight.

Subsequently, the open-pored, elastic absorber layer 8 (noise damping layer) is laid on the heavy layer compound 10 introduced into the cavity 3. The absorber layer 8 is preferably made of an open-pored foam which has a compression hardness σ_{d40} of not less than 4 kPa and a permanent set in the range from 3 to 6% (upon prior compression by 50% and 72-hour storage at 70° C.). Such a foam layer has a high recovery capability, which is advantageous for achieving the largest possible absorber volume after completing the mold pressing procedure. The compression hardness σ_{d40} is understood as the pressure tension required for a deformation of 40% (compare DIN EN ISO 3386-1/2). The permanent set is defined in DIN EN ISO 1856. Accordingly, cuboids of 50 mm×50 mm×25 mm in the thickness of 25 mm are compressed by 50 or 75% between steel plates stored for 72 hours at standard climate or at 70° C. The permanent set is the plastic deformation component (remaining deformation) in percent remaining after relaxation.

The absorber layer 8 preferably comprises soft elastic open-pored PUR foam of the polyether type. For example, it has an original layer thickness in the range from 10 to 50 mm. The absorber layer 8 may be implemented as single-layer or multilayered. In particular, it may be externally coated with a nonwoven material, such as a spunbonded nonwoven material.

The absorber layer 8 is laid on the heavy layer compound in the form of a plate-shaped blank or foamed injection molded part. The laying is preferably performed using a robot. Alternatively, the absorber layer 8 may also be made of multiple blanks and/or foamed injection molded parts. The blank(s) and/or the foamed injection molded part(s) are dimensioned in such a way that no absorber material is cut off on the flash edge 4 of the lower tool 1 upon closing of the mold 1, 2, so that the operation may be performed waste-free overall.

By closing the press, the plasticized underlay material 10 is pressed in the cavity 3 into the shape of the heavy layer 7 while flowing and forms webs 9 which are pressed into and/or through the absorber layer 8 in the absorber layer 8 (compare FIG. 2). In the area of the raised press panels 6, the underlay material 10, in contrast, penetrates only slightly into the absorber layer 8, so that a material bond which is more or less restricted to the surfaces of heavy layer 7 and absorber layer 8 occurs there. The relatively high recovery capability of the elastic absorber material or foam ensures that after the opening of the molds 1, 2, cushion-like areas 11 result between the webs 9 of the finished composite part 12.

In the molds shown in FIG. 1, the recesses 5 forming the webs 9 are implemented essentially equally deep and equally wide. Correspondingly, a heavy layer 7 having webs 9 implemented in one piece thereon, which are essentially equally high and equally wide, results. The recesses 5 and, accordingly, the webs 9 are preferably implemented in a grid (lattice), so that they define boxes which are implemented as polygonal, for example, triangular and/or rectangular, particularly square.

As may be seen in FIG. 2 in particular, the cushion-like areas 11 of the absorber layer 8 have different thicknesses, although the absorber layer 8 compressed with the heavy layer compound 10 originally had an essentially uniform thickness. The thickness of the cushion-like absorber areas 11 (absorber strips and/or absorber fields) is a function of the spacing of the recesses 5 or webs 9. The larger the spacing or the boxes formed by the webs 9 are, the thicker the cushion-like areas 11, the maximum thickness corresponding to the original thickness of the absorber layer 8 before the compression.

The absorber areas 11 projecting like cushions in relation to the webs 9 are not only of different thicknesses, rather they also have different degrees of compression and/or flow resistances. In the areas in which the webs 9 are positioned with relatively little spacing from one another, the absorber layer 8 is squeezed more and therefore compressed more strongly than in areas in which the webs 9 are positioned with greater spacing from one another. The absorber layer 8 has the lowest degree of compression and therefore the lowest flow resistance where it may possibly return to its original thickness. The implementation of absorber areas 11 of different sizes and thicknesses projecting like cushions in relation to the webs 9 therefore allows not only geometrical adaptation of the composite material to height differences and/or depressions of an underlying vehicle body sheet metal; through the local variation of the degree of compression and/or flow resistance of the absorber layer 8 connected thereto, the bandwidth of the sound absorption may also be set differently locally.

In the exemplary embodiment shown in FIGS. 3 and 4, the recesses 5 or webs 9 are not only at different distances from one another, the recesses 5 additionally have different depths and the webs 9 correspondingly have different heights. The web heights may, for example, be in the range from 3 to 70 mm. The recesses 5 and, accordingly, the webs 9 are preferably implemented like a lattice here also. The depth of the recesses 5 is less than the original thickness (starting thickness) of the absorber layer 8.

Through the implementation of different web heights and/or the implementation of absorber areas 11 of different thicknesses, the composite part 12 according to the present invention may be adapted to the geometrical contour of the installation location.

Furthermore, implementing areas of different thickness and/or density in the heavy layer 7 is in the scope of the present invention. This is illustrated as an example in FIGS. 5 and 6. It can be seen that the press panels 6 divided by the recesses 5 project in different distances in the direction of the cavity 3. The press panels 6 are again implemented in different sizes here, specific press panels 6′ having essentially horizontal press areas and other press panels 6″ having press areas running obliquely thereto. Furthermore, it may be seen that the recesses 5 have different depths as well as different widths. The local thickness and/or density of the heavy layer 7 is selected as a function of the acoustic requirements at the installation location of the composite part 12′.

The composite part 12, 12′ according to the present invention may, for example, be implemented as a dash wall lining of a motor vehicle. Another preferred use is as a motor vehicle floor lining. In both cases, the heavy layer 7 may be coated on its side facing away from the absorber layer 8 with a further absorber layer 13, particularly a foam layer, a nonwoven material layer, and/or a carpet product.

In a preferred exemplary embodiment, the heavy layer 7 is provided on its side facing away from the absorber layer 8 with a further sound-absorbing foam layer 13 and a carpet product 14 connected thereto. In this case, the connection of the carpet product 14 to the foam layer 13 is implemented as acoustically open. The connection may, for example, comprise an adhesive bond, the adhesive being applied in a net shape on the carpet back. Sound to be absorbed may therefore penetrate through the flow-open carpet product and the open mesh of the adhesive net into the foam layer 13. In this case, the adhesive preferably contain ceramic microbodies and/or hollow microbodies. Microbodies of this type are used for stiffening the molded carpet product. The hollow microbodies are relatively light in this case and acoustically effective because of the air enclosed therein.

To manufacture a composite part 12 of this type, first a carpet product 14, which has an open-pored elastic absorber layer 13 laminated on the back, is laid with its decorative side downward in the cavity 3 of the molding press. The absorber layer 13 may have a thickness in the range from 4 to 10 mm, for example. A specific volume of an extruded heavy layer compound 10, such as PE-EVA, is then applied to this absorber layer 13 in the melt application molding method and subsequently—as described above—a second absorber layer 8 is laid on, which has a thickness of the range from 10 to 50 mm. The two absorber layers 8, 13 preferably comprise soft elastic PUR foam of the polyether type having the values specified above for the compression hardness σ_{d40} and the permanent set. Finally, the material layers 8, 10, 14, and 13 are pressed together in the molding press, the heavy layer material 10 being pressed into the shape of the heavy layer 7 while flowing and forming webs 9 pressed into and/or through the second absorber layer 8 at the same time (compare FIGS. 1 through 6).

FIG. 7 shows the bottom of a carpet constructed according to the present invention, the second absorber layer 8 largely being left out for better illustration of the ribbing formed by the webs 9. A trough-shaped impression 15 is implemented in the carpet, which is used for the adaptation of the carpet to a transmission tunnel or the like, for example. In particular, it may be seen that the webs 9 of the heavy layer 7 have different heights. The different web heights are used for adapting the carpet construction to the contour of the vehicle floor sheet metal.

The implementation of the present invention is not restricted to the exemplary embodiments described above. Rather, an array of variations are conceivable, which also make use of the ideas of the present invention specified in the attached claims even with a significantly differing design. Thus, for example, protrusions and/or depressions may also be implemented in the cavity 3 of the lower tool 1, which cause the formation of areas of different thickness and/or density in the heavy layer 7. Furthermore, the molds 1, 2 may have pin-like projections and recesses assigned thereto, using which openings and/or socket-shaped impressions may be implemented in the sound-insulating composite part 12, 12′ for conducting through cable strands, hose lines, and the like.

1. A sound-insulating composite part, particularly for motor vehicles, comprising a heavy layer (7) and at least one absorber layer (8) made of open-pored, elastic absorbing material, multiple webs (9), which are made of the material of the heavy layer, being molded in a grid on the heavy layer (7), and the heavy layer material forming the webs (9) being pressed through the absorber layer, wherein the webs (9) divide the absorber layer (8) into multiple absorber areas (11) of different sizes and different thicknesses, which project like cushions in relation to the webs (9).

2. The composite part according to claim 1, wherein the webs (9) comprise webs of different heights and/or different widths.

3. The composite part according to claim 1, wherein the heavy layer (7) has areas of different thickness and/or density.

4. The composite part according to claim 1, wherein the absorber layer (8) is made of polyurethane foam of the polyether type.

5. The composite part according to claim 1, wherein the absorber layer (8, 13) is made of a foam which as a compression hardness of σ_{d40} of not less than 4 kPa and a permanent set upon prior compression by 50% and a 72-hour storage at 70° C. in the range from 3 to 6%.

6. The composite part according to claim 1, wherein the heavy layer (7) is coated with a further absorber layer (13, 14) on its side facing away from the absorber layer (8).

7. The composite part according to claim 6, wherein the further absorber layer (13) comprises a foam layer, nonwoven material layer, and/or carpet product (14).

8. The composite part according to claim 1, wherein the heavy layer (7) is provided with a further absorber layer (13) and a carpet product (14) connected thereto on its side facing away from the absorber layer (8).

9. The composite part according to claim 8, wherein the connection of the carpet product (14) to the further absorber layer (13) is implemented as acoustically open.

10. The composite part according to claim 8, wherein the carpet product (14) and the further absorber layer (13) are glued to one another, the adhesive containing ceramic microbodies and/or hollow microbodies.
